(19) United States
(12) Patent Application Publication
(10) Pub. No.: US 2017/0345334 A1
(43) Pub. Date: Nov. 30, 2017

(54) Online Training with Live Instruction

(71) Applicant: Michael DiGiorgio, Hasbrouck Heights, NJ (US)

(72) Inventor: Michael DiGiorgio, Hasbrouck Heights, NJ (US)

(21) Appl. No.: 15/604,257

(22) Filed: May 24, 2017

Related U.S. Application Data
(60) Provisional application No. 62/341,471, filed on May 25, 2016.

(51) Int. Cl. G09B 19/00; G09B 5/06; G09B 3/00

(52) U.S. Cl. CPC G09B 19/003; G09B 3/00; G09B 5/065

(57) ABSTRACT

An improved remote teaching system, whereby the instructor(s) may interact with the audience through interactive instruction, culminating in one or more proctored examinations to ensure necessary learning for safety and legal compliance. Increased frequency of and access to classes, and decreased costs will be among the benefits provided.

### CROSS-REFERENCE TO RELATED APPLICATIONS

This application claims priority to U.S. Provisional Patent Application No. 62/341,471, filed May 25, 2017, which is hereby included by reference in its entirety.

### BACKGROUND OF THE INVENTION

### Field of the Invention

The present invention generally relates to a system for teaching an audience at one or more locations, using a live instructor, wherein the audience may be at (a) different location(s) than the instructor. More specifically, the invention relates to the teaching of safe transportation and handling of hydrocarbons, particularly propane. Traditionally, remote education systems have been limited in their ability to address student concerns and provide adequate feedback. The present invention enables the instructor to maintain contact with the audience and to continue to address and respond to the needs and concerns of the audience.

### DISCUSSION OF THE PRIOR ART

U.S. Pat. No. 6,871,195, issued to Ryan, et al, teaches a computer system to track employee productivity and effectiveness. The system allows a supervisor to monitor an employee's activities, as well as to analyze the employee's performance, so that it can be modified to correct for any shortcomings or defects. When employed properly, the system enables a supervisor to mentor employees, thus enabling them to perform their duties in a safe and efficient manner.

U.S. Pat. No. 5,870,755 ('755 patent), issued to Stevens, et al, teaches a method of conducting synthetic interviews. The computer program described by the '755 patent logs targeted information in order to facilitate a dialogue between a virtual person and a live human being. The program captures statements, analyzes those statements to form questions, and then asks the corresponding questions, according to the program. Its design is to facilitate learning by providing an interactive agent, without the expense of coding specific responses into the program, or in the alternative, some form of artificial intelligence.

U.S. Pat. No. 6,099,320, issued to Papadopoulos, teaches a computer-based learning system, controlled by the user. The system here is self-paced, in that the user is allowed to determine how fast he or she wishes to progress through the training. Moreover, the interface is designed to be non-intimidating, so as to emphasize learning the material, rather than learning how to manipulate the interface itself. Courses must be completed in a pre-determined order. The system logs completion of the courses and notifies a course administrator when one is completed.

U.S. Pat. No. 6,408,315 ('315 patent), issued to McManus, et al, teaches a computer-based training system that includes multimedia presentations. The system taught by the '315 patent utilizes the internet to reach audiences beyond the immediate source of the training, unlike in a traditional live-instructor session. The training concludes with a computer-based examination, which provides the student with feedback upon completion of the examination.

U.S. Pat. No. 6,498,920, issued to Simon, teaches a web-based training system that can be customized to fit the needs of a particular user. The material can be selected and tailored by authorized company personnel, to ensure that the training provides a particular employee with the proper knowledge and understanding to perform the employee's job functions. The training culminates in a web-based examination, the results of which are logged by the program.

U.S. Pat. No. 6,559,867, issued to Kotick, teaches an interactive training network designed for a plurality of students. Students working at computer work stations, share a network with an instructor, who can monitor their activities and respond to a particular student's inquiries or concerns. The instructor can assess the response by monitoring any given student's workstation. Select embodiments are directed toward military command centers, where a plurality of participants work under the supervision of one or more leader, who must monitor their activities and evaluate their responses.

U.S. Pat. No. 6,928,260, issued to Betz, et al, teaches an online learning system with at least one student networked to an instructor, whereby at least one lesson can pass from the instructor's system to the at least one student's. Students are required to register to use the system, and their progress is tracked. Upon completion of the training, including examination, if necessary, students are issued a certificate of completion. The system analyzes the students' answers to determine whether they were actively taking the examination, or merely guessing, in which case certification would be improper.

U.S. Pat. No. 9,064,232, issued to Laine, et al, teaches a system for instructing both in-person and remote students, with the latter utilizing a computer network. Additionally, remote participants are provided with additional exercises, to be completed on the network.

### SUMMARY OF THE INVENTION

The invention generally relates to an electronic learning system, which includes live instruction and active participation by both the instructor and the audience.

There has been thus outlined, rather broadly, some of the features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

Online learning is a well-known phenomenon, as the identified references indicate. However, the applications have been limited, and most notably they do not normally provide for live interaction between the instructor and the audience. When live interaction is available, however, is frequently impractical, either due to lack of available instructors or the often exorbitant cost of sending an entire class to an instructor's location. The present invention seeks to correct this deficiency and ensure that the audience achieves both the benefit of a live instructor and the cost savings associated with online learning.

The current invention allows an instructor (or proctor) to reach a potentially unlimited audience, even across multiple venues. The instructor would broadcast through streaming video, to at least one location's receiving apparatus, where a number of students could observe the lesson and partake in the discussion. This discussion would be dynamic, engaging the audience as an active participant, rather than a passive observer. Thus, even students on the opposite side of the world could have the same meaningful learning experience as those in the next room from the instructor.

Under currently-practiced systems, students are typically taught either in person by a live instructor, or by observing pre-recorded videos. The former is generally preferable, as it allows the potential for interaction and more specific learning to be possible. However, it is frequently impractical. This option requires either the instructor to go to the audience, or the audience to go to the instructor. Both require substantial preparation and planning, in order to make the process effective and efficient. In the event the instructor is ill or otherwise indisposed, an in-person class may be impossible. This can result in the class being cancelled with little or no notice. Moreover, it is of significant difficulty to train a large audience by having a live instructor present, due to spatial limits. High-demand courses, such as industry certifications, are taught by specially-trained instructors, who may not be readily available. This dictates that the maximum number of students be present whenever a course is held. Large audiences, therefore, require large seating capacity. Renting out large venues is expensive, and must be done well in advance, to prevent conflicts with other events. Effective cooperation among all potential audiences becomes necessary in such situations, to maximize efficiency and best utilize the resources available. Thus, students from various areas or companies are combined into a single venue, and coordinated efforts are required to ensure that the operation proceeds smoothly.

The other alternative, pre-recorded sessions, is significantly more cost effective, but far less ideal. These sessions can be out of date, and do not afford students an opportunity to communicate with the instructor, relying instead on themselves and their classmates to resolve any questions or concerns that may arise. However, these sessions are much easier to coordinate, since they require little if any special planning, and are easily rescheduled if conflicts should arise. Similarly, they can be conducted for small or large groups, with essentially the same cost and requirements. Unfortunately, due to their static nature, they cannot respond to particular class needs or questions, nor can they readily adapt to changes in technology. Thus, while preferable from a cost perspective, they are not ideal.

The present invention addresses the shortcomings of both methods described above, providing a more effective learning solution. Under the present invention, a live instructor remotely broadcasts to one or more audiences, while maintaining live audio-visual connections between the instructor(s) and each audience. This arrangement enables the instructor to receive real-time questions and feedback from the audience members, and address these questions or respond to feedback as necessary and appropriate. Moreover, not all attendees need be in the same space in order to participate. A single instructor can teach a course in Los Angeles, Miami, and Cleveland at the same time, without sacrificing the quality of the course.

In one preferred embodiment, the invention is utilized in the petrochemical industry according to common practices. The invention comprises the steps of obtaining and securing materials, verifying adequacy of audio-visual equipment for the course purposes, registering students for the course, providing information to the students for the course, conducting the class, providing exam preparation, administering the exam under controlled guidelines, grading the exam, and either contacting the instructor if the student does not pass, or issuing a certificate of completion and providing successful students with additional opportunities to ensure their proficiency.

In another preferred embodiment, the invention comprises the same steps, but further comprises tailoring the material to the propane industry. The training materials required to utilize this embodiment are presently available from the Propane Education and Research Council (PERC). Additionally, examinations can be handled by agencies that specialize in handling examinations, such as Industrial Training Services (ITS).

In either of the above preferred embodiments, the invention can incorporate computer-generated resources, such as virtual models of equipment, to demonstrate how a particular device functions in the field. These resources could provide a more effective learning experience than cut-away models, which traditionally showed only an internal view of the mechanism, but not its functionality.

In another preferred embodiment, the invention can be used to teach safe handling of hydrocarbons other than propane. In such an embodiment, training materials may be available from sources other than PERC, and may include various federal, state, local, and industry agencies.

In yet another preferred embodiment, the invention can be used to teach safe handling of other materials with stringent requirements for safe handling, not limited to but including biofuels, food, pharmaceuticals, and nuclear material. As in the immediately preceding preferred embodiment, training materials could be sourced from the appropriate federal, state, local, and industry agencies.

Such embodiments do not represent the full scope of the invention. Reference is made therefore to the claims herein for interpreting the full scope of the invention. Other objects of the present invention, as well as particular features, elements, and advantages thereof, will be elucidated or become apparent from, the following description and the accompanying drawing FIGURES.

### BRIEF DESCRIPTION OF THE DRAWINGS

Other features of my invention will become more evident from a consideration of the following brief descriptions of drawings:

FIG. 1 is a front view of the present invention. This depicts the process by which the invention is carried out, from start to finish.

### DETAILED DESCRIPTION OF THE PREFERRED EMBODIMENT

Referring now the drawings with more specificity, the present invention essentially provides an improved method of remotely instructing a class. The classes can be general in nature, or can incorporate varying degrees of specificity and complexity, depending upon the needs of the audience. In addition the system can be able to account for and work with several other variables and features discussed below.

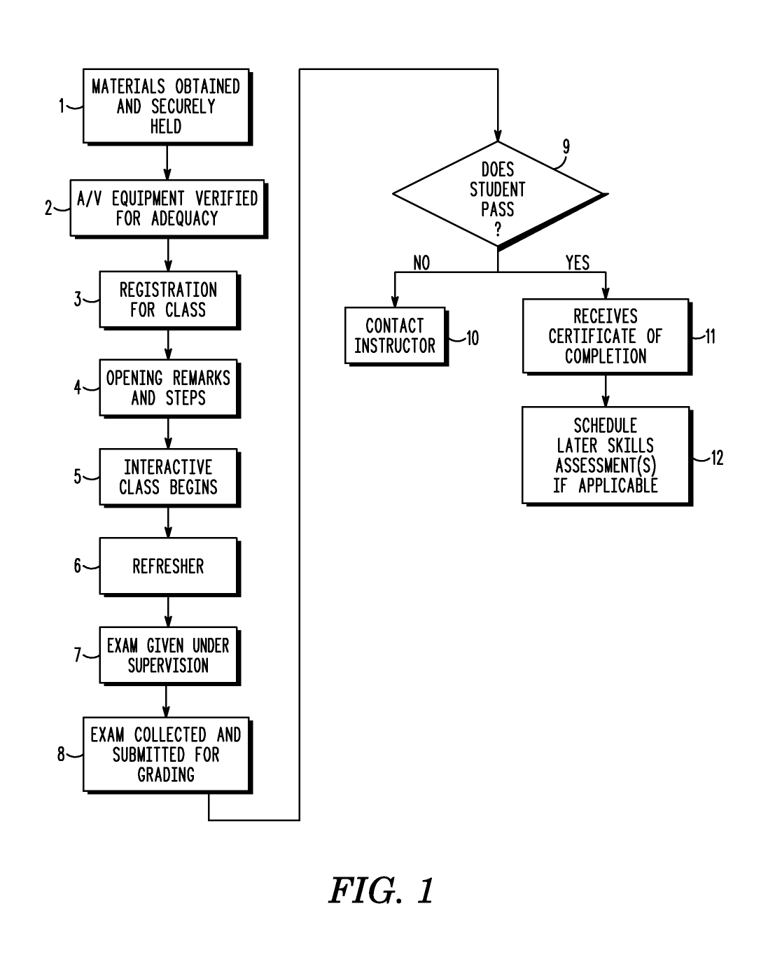

Looking now to FIG. 1 a representative training pathway is shown. As shown, the process begins with the entity (or entities) hosting the training obtaining and securely holding the materials required for the course, including examination materials 1. Ideally, they will be held by an agent whose position requires supervision and ethics monitoring, but alternative parties may be acceptable if prior approval is received. Once materials are obtained and secured, the hosting venue's (or venues', if more than one location is hosting students) audio-visual equipment is/are checked, to ensure it/they will be adequate to facilitate the training session 2. Next, each individual wishing to take the course will register for the course electronically, either directly or through a third-party 3. Not later than the night before the class, all registered attendees will receive information on how to access the course. Immediately before the class begins, the instructor will commence with opening activities and initial remarks 4. Next, the instructor will begin the interactive class session 5. A number of tactics and devices may be incorporated here, including but not limited to: mnemonic devices, color-coordinated materials, horns, sirens, videos, pictures, etc. After conclusion of instruction, the instructor will conduct a review and/or refresher session with the audience, prior to the examination, to address any remaining concerns and to ensure the highest possible rates of student success on the examination to follow 6. Following the refresher, a break may be provided for the students, although this may not be necessary, depending upon the nature of the examination and the course of study. Immediately before the exam begins, the instructor will begin recording at each site where examination will take place. This recording will continue at least until the exams are completed and collected. At least one on-site proctor will retrieve the exams from secure storage, and will then demonstrate to the camera that the exams are still in the sealed package in which they arrived. Only after the instructor is satisfied that the exams have not been compromised, the in-room proctor(s) will break the seal on the package and distribute the examination booklets to the class. The instructor will continue to monitor the venue(s) during the entire examination session. Students will have their registration numbers matched up to examination materials, to ensure that all materials are accounted for prior to beginning the examination. Upon the instructor's prompt, students will begin and complete the examination 7. Once the time for the examination has concluded, the instructor will call time, and all students must stop work on the examination materials. The on-site proctor(s) will collect and seal the examinations, and prepare them for delivery to the party responsible for grading them 8. Only after the examinations are collected and sealed will the instructor terminate the recording. The instructor or his designee will retain the recording for at least such time as is required to ensure that no questions or challenges can be raised as to the validity of the examination results. After the examinations are graded, passing and failing results will be released, and students will receive their results 9. If the students do not pass, they will be able to contact the instructor to make arrangements to retake the course 10. If they pass, they will receive their certificate of completion, and may schedule for additional courses or follow-up assessments, if required 11.

Accordingly, although the invention has been described by reference to certain preferred and alternative embodiments, it is not intended that the novel arrangements be limited thereby, but that modifications thereof are intended to be included as falling within the broad scope and spirit of the foregoing disclosures and the appended drawings.

I claim:

1. A method for providing online education comprising:
an employee of a hosting venue obtaining requisite materials for a particular course from the Propane Education and Research Council (PERC) and Industrial Training Services (ITS), including examinations having examination numbers;
said examinations having been previously secured with at least one seal and said at least one seal remaining unbroken;
said employee placing said requisite materials in a secured location, inaccessible to students taking the particular course;
verifying the sufficiency of all audio-visual equipment to be used by the hosting venue for the purposes of the particular course;
registering students for the particular course;
providing students with information as to accessing the particular course;
in-person registration of all students for the particular course;
as part of said in-person registration, validating identification and prior registration status of all students prior to beginning the particular course;
upon validation of registration and identification of all students, providing said students with necessary course materials, excluding examinations;
commencement of opening announcements and remarks by an instructor;
said instructor leading the particular course in a highly interactive fashion;
said instructor providing a final review session after termination of the particular course;
the instructor recording the venue, beginning at some time shortly after termination of the particular course and while the examinations are still in the secured location;
the employee of the hosting venue retrieving the examinations from their secured location;
the employee of the hosting venue breaking the at least one seal only after the instructor so authorizes;
the employee of the hosting venue recording each examinations exam number with each student's registration number;
upon authorization of the instructor, commencing the examination;
the instructor monitoring students while taking the examination;
the employee of the hosting venue collecting and sealing all examinations upon completion of time allotted for the examination by the instructor;
the instructor terminating recording of the venue after the completed exams are sealed;
the instructor retaining the recording of the examination session for at least such time is required to validate any subsequent certifications which may issue;
grading the examinations and determining whether each student passed or failed;
informing failing students of their results;
providing failing students an opportunity to contact the instructor to retake the particular course;
notifying passing students of their results;
providing passing students with any appropriate certificates;
allowing passing students access to later skill assessments, if applicable; and
providing passing students with continued contact to the instructor to address questions after completion of the particular course.

2. A method for providing online education comprising:
an employee of a hosting venue obtaining requisite materials for a particular course, including examinations having examination numbers;
said examinations having been previously secured with at least one seal and said at least one seal remaining unbroken;
said employee placing said requisite materials in a secured location, inaccessible to students taking the particular course;
verifying the sufficiency of all audio-visual equipment to be used by the hosting venue for the purposes of the particular course;
registering students for the particular course;
providing students with information as to accessing the particular course;
in-person registration of all students for the particular course;
as part of said in-person registration, validating identification and prior registration status of all students prior to beginning the particular course;
upon validation of registration and identification of all students, providing said students with necessary course materials, excluding examinations;
commencement of opening announcements and remarks by an instructor;
said instructor leading the particular course in a highly interactive fashion;
said instructor providing a final review session after termination of the particular course;
the instructor recording the venue, beginning at some time shortly after termination of the particular course and while the examinations are still in the secured location;
the employee of the hosting venue retrieving the examinations from their secured location;
the employee of the hosting venue breaking the at least one seal only after the instructor so authorizes;
the employee of the hosting venue recording each examinations exam number with each student's registration number;
upon authorization of the instructor, commencing the examination;
the instructor monitoring students while taking the examination;
the employee of the hosting venue collecting and sealing all examinations upon completion of time allotted for the examination by the instructor;
the instructor terminating recording of the venue after the completed exams are sealed;
the instructor retaining the recording of the examination session for at least such time is required to comply with applicable guidelines;
grading the examinations and determining whether each student passed or failed;
informing failing students of their results;
providing failing students an opportunity to contact the instructor to retake the particular course;
notifying passing students of their results;
providing passing students with any appropriate certificates;
allowing passing students access to later skill assessments, if applicable; and
providing passing students with continued contact to the instructor to address questions after completion of the particular course.

3. The method of claim 2 wherein:
the subject matter of the particular course pertains to the safe handling and transportation of flammable materials.

4. The method of claim 3, wherein:
the flammable material is a solvent.

5. The method of claim 3, wherein:
the flammable material is capable of being used as a fuel source.

6. The method of claim 3 wherein:
the flammable materials comprise at least one hydrocarbon.

7. The method of claim 6 wherein:
the at least one hydrocarbon is propane.

8. The method of claim 3, wherein:
the flammable material is petrochemical in nature.

9. The method of claim 2, wherein:
the particular course is directed toward safe handling of pharmaceuticals.

10. The method of claim 2, wherein:
the particular course is directed toward safe handling of carcinogenic materials.

11. The method of claim 2, wherein:
the particular course is directed toward the proper handling of substances intended to be used for consumption by living organisms.

12. The method of claim 2, wherein:
the particular course is directed toward human resources training.

13. The method of claim 2, further comprising:
the instructor providing continuing availability to passing students;
said continuing availability including virtual assistance for concerns not addressed during the particular course.

14. The method of claim 2, further comprising:
the instructor providing continuing availability to passing students;
said continuing availability including virtual assistance for situations in which a passing student lacks certainty as to proper handling for a particular situation.

15. The method of claim 2, wherein:
the interactive course includes at least one device to facilitate learning from the following set:
(a) sirens;
(b) alarms;
(c) games;
(d) color-coordinated materials;
(e) mnemonic devices;
(f) handouts;
(g) sample equipment;
(h) videos; and
(i) images.

16. The method of claim 2, wherein:
students are encouraged to develop their own learning aids.

17. The method of claim 2, wherein:
the particular course is directed to problem solving in situations requiring immediate responses.

18. The method of claim 2, wherein:
the instructor maintains certification as a proctor for subject matter to be covered by the particular course.

19. The method of claim 2, wherein:
the particular course is directed to certifying students as proctors in the particular course's subject matter.

20. The method of claim 2, wherein:
the particular course is directed to nuclear material.
